(19) United States
(12) Patent Application Publication
(10) Pub. No.: US 2026/0202009 A1
(43) Pub. Date: Jul. 16, 2026

(54) EQUIPMENT-SECURING MEANS FOR PORTABLE ITEMS OF EQUIPMENT

(71) Applicant: REELOQ GMBH, Graz (AT)

(72) Inventors: Lukas Walzinger, Graz (AT); Sandro Dickbauer, Graz (AT)

(73) Assignee: REELOQ GMBH, Graz (AT)

(21) Appl. No.: 19/136,274

(22) PCT Filed: Dec. 4, 2023
(86) PCT No.: PCT/AT2023/060426

§ 371 Date: Jun. 5, 2025

(30) Foreign Application Priority Data
Dec. 6, 2022 (AT) 60192/2022
Nov. 16, 2023 (AT) A50931/2023

(51) Int. Cl. F16M 13/02

(52) U.S. Cl. CPC F16M 13/022

(57) ABSTRACT

An equipment-securing means (100) for portable items is disclosed that includes a housing enclosing a reel (7) and a restoring element (11), a pulling element (4) for fastening items, and an arresting mechanism. The restoring element (11) subjects the reel (7) to a tensile force in the direction of the interior space of the housing, so that the pulling element (4) can be rolled up. The arresting mechanism includes a control-runway element (9) connected to the reel (7) via a freewheel (10), which has two guideways and a control guideway (27) running between the guideways and having an arresting-element arresting position (21), and also has ramps (22) between the individual guideways and an arresting element (8), which engages in the control-runway element (9). One of the guideways receives the arresting element (8) to extend the pulling element (4) out of the housing and/or roll it up on the reel (7).

The invention relates to an equipment-securing means for portable items of equipment, in particular portable tools, according to the preamble of claim 1.

In many situations it is desirable for portable equipment to be safeguarded against falling. In height-related work—for example in the industrial climbing sector or in tree-care operations—it is advantageous if items of equipment such as tools or smartphones are protected against falling while in use. In extreme deployment scenarios it is likewise helpful for the firefighters, paramedics or police officers involved to have their items of equipment reliably secured on their person against falling and theft, so that they can act quickly and efficiently. In outdoor sports, such as climbing, it is also desirable for items of equipment to be secured against falling. The hazards and problems associated with a fall of equipment are marked above all by the high risk of injury to both involved and uninvolved persons.

Another aspect is that picking up equipment that has fallen always entails additional effort for the user, because the user must take extra actions to recover the lost item. Industrial climbing or tree care takes place in environments where such extra actions—such as an unplanned descent—are difficult to carry out because the user himself is secured against falling in several ways. Aside from the considerable danger for all concerned, a dropped item of equipment can therefore mean a great deal of extra work for the user, or the item may even be destroyed. In extreme deployment scenarios any time loss should be avoided as far as possible, and users always wish to know that equipment which has slipped from their hands is nonetheless secured. Items of equipment that fall during outdoor sports such as climbing likewise pose a significant safety risk.

To minimise or eliminate the danger of equipment falling, it is known practice to attach a loose line, cord or rope—referred to below as a pulling element—at one end to the item of equipment to be secured and at the other end to the user's clothing, climbing harness or the like, or to a rigid or approximately rigid connection near the user, such as a wall or scaffold.

One problem with such loose pulling elements is that the loose line, cord or rope constantly acts like a loop and therefore always constitutes a potential source of danger, especially in height-related work but also in deployment scenarios. This applies in particular, though not exclusively, when the secured item is not being used. A loose dangling pulling element entails the risk that it may entangle the user or become snarled, hindering the user. This presents a substantial danger potential both in height-related work and in deployment scenarios and outdoor sports such as climbing.

A further problem is that, in the event of a fall of the equipment, enormous impact loads act on both the device and the user. The reason is the low elasticity of such loose pulling elements. In the worst case such high dynamic forces arise that the pulling element ruptures and, despite being attached, the item of equipment may nonetheless fall to the ground. Even if the pulling element withstands the enormous dynamic loads, injuries to the user can occur because the impact load is transmitted to the user's body, giving rise to the risk of bone fractures and the like.

In order to prevent the pulling element from becoming entangled or snarled, extendable safety lines or safety ropes are known from the prior art. These extendable safety lines or ropes are usually configured so that the pulling element is rolled up onto a reel and can be reeled back into a housing. In this way the risk of the pulling element becoming tangled or snarled while the equipment is being used is minimised or eliminated entirely.

Another known measure for improving the use of an extendable equipment-fall-protection means is to “lock” the retraction force acting on the pulling element, which is required in order to rewind the element into the housing. This can be done manually via a button or automatically during extension. US 2008/054116 A1 discloses a ratchet mechanism that locks and unlocks the pull on the rope, cord or line. US 2009084697 A1 likewise achieves this by means of a ratchet mechanism that locks the pull at certain intervals, while no locking action is present in other intervals. AT 521 616 B1 discloses an arrangement in which a pulling element or rope pull—and consequently a running reel—is locked only when the extendable pulling element is fully extended.

The known systems are disadvantageous, firstly, because of their generally delicate construction and, secondly, because of their poor user-friendliness. Awkward manipulation is often required to actuate and release the arresting mechanism. Another negative aspect is that the mechanisms are not optimally matched to the user's typical pattern of use, as the user often has to find particular intervals in which the arresting mechanism actually locks or unlocks.

The object of the invention is therefore to provide a remedy in this respect and to furnish an equipment-securing means that is of robust construction and easy to operate while at the same time ensuring effective safeguarding of the equipment against falling, with maximum freedom of movement for the user while working with the secured equipment.

The invention solves this problem with an equipment-securing means for portable items of equipment, in particular portable tools, according to the preamble of claim 1 by the characterising features of claim 1.

According to the invention, an arresting mechanism is provided, comprising
a control-runway element that is connected to the reel via a freewheel and has two concentrically extending guideways spaced radially apart from one another, in particular of annular or annular-sector shape, and a control guideway extending concentrically between the guideways, likewise of annular or annular-sector shape, the control guideway having an arresting-element arresting position, with ramps arranged between the individual ways, and
an arresting element that engages in the control-runway element and is guided within the guideways and the control guideway and/or along the ramps of the control-runway element, together with
guideways, control guideway and ramps that are designed and arranged relative to one another so that
   by pulling on the pulling element with a force greater than the force exerted on the reel by the restoring element, the pulling element can be pulled out of the housing and the arresting element can move freely in one of the guideways, so that the control-runway element rotates with the reel,
   when a pulling force directed away from the housing which is less than the force exerted on the reel by the restoring element acts on the pulling element, the pulling element is retracted into the housing by the restoring element and the arresting element can be pushed out of one of the guideways via a ramp into the control guideway and brought into the arresting-element arresting position, whereby rotation of the reel relative to the housing is blocked, and
   when the arresting element is located outside the arresting-element arresting position, the reel can be rotated relative to the housing,
the arrangement being such that, if a pulling force directed away from the housing and greater than the force exerted on the reel by the restoring element acts on the pulling element, the arresting element can be guided out of the arresting-element arresting position via a ramp onto the control guideway and/or one of the guideways and the pulling element can be pulled out of the housing and/or rolled up on the reel.

An equipment-securing means according to the invention therefore includes an arresting mechanism that can block the restoring force acting on the extendable pulling element. This enables the user to work with items of equipment secured by an equipment-securing means according to the invention in a particularly simple and safe way. In addition, with the use of an equipment-securing means according to the invention, while the mechanism is locked the user can use the secured equipment without any interfering pulling force.

The reel can, according to the invention, be locked in any desired unrolled position—in particular once in every revolution or at least by latching into the next interval when the pulling element is extended. Only a further pull of any length—whether short or long, at most until the pulling element is fully extended—releases the reel again and the pulling element is rolled up. With known mechanisms a short pull would immediately retract the element, while a longer pull (for example more than half a revolution) would lock the reel again in the next, longer position. An equipment-securing means according to the invention therefore lets the user lock the reel in any chosen position and unlock it again by a further pull, without having to ensure that the pulling element or reel is locked again at the next interval as in the known state of the art.

Apart from this, the construction and realisation of the arresting mechanism in an equipment-securing means according to the invention are particularly advantageous compared with known arresting mechanisms, because they allow a highly space-saving integration inside the housing of such extendable equipment fall-protection devices. Furthermore, the simple manufacturability and high reliability of the individual components are especially beneficial, and the components of an arresting mechanism according to the invention—or of an equipment-securing means according to the invention—can also be dimensioned to be as small, as large and as robust as desired.

Further advantageous embodiments of the equipment-securing means are set out in the dependent claims.

According to an advantageous variant of an equipment-securing means according to the invention, it can be provided that the freewheel element is configured as a leg spring or a torsion spring, the leg spring being fixed to an encircling pin arranged on the reel and one end of the leg spring or torsion spring being connected to the control-runway element, so that the control-runway element is freely rotatable only in the free-running direction. In this way it is advantageously possible for the encirclement of the spring around the encircling pin to increase the encircling force in the locking direction—and consequently the frictional force—to such an extent that rotation is no longer possible. Furthermore, especially when a leg spring is used, a minimal counter-acting force can be produced in the free-running direction. This has a particularly positive effect on the user-friendliness of an equipment-securing means according to the invention: on the one hand the user needs to apply less force when pulling out the pulling element, which is especially advantageous because, for example, construction workers would otherwise become fatigued very quickly by frequent pulling at high extraction forces; on the other hand a minimal counter-acting force has a positive effect on the locking action of the arresting mechanism, because otherwise the arresting element might not reliably jump over the ramps. That is, the freewheel element advantageously ensures at least the counter-force that is necessary for the arresting element to be able to slide over the individual ramps.

Particularly effective restoring elements can be provided when the restoring element is formed as a spiral spring or a torsion spring. By selecting the restoring element in this way a long service life of the holding device can be achieved without the restoring element showing fatigue, so that the pulling element is rolled faultlessly onto the reel element throughout the entire service life of the holding device. Configuring the spring element as a spiral-shaped spring also advantageously ensures a compact, space-saving design of the arresting mechanism.

A particularly space-saving and at the same time robust and reliably locking arresting element can be achieved when the arresting element includes an arresting-element pin that engages in the control-runway element and is guided in its guideways.

The arresting mechanism of an equipment-securing means according to the invention can be designed to be particularly space-saving if the arresting element is configured as a slider that is displaceable along an axis in guides arranged on or formed in the housing. In this configuration, the arresting element can advantageously be accommodated inside the reel.

According to a further advantageous embodiment of an equipment-securing means according to the invention, it can be provided that the arresting element is designed as a lever arranged on the housing and extending towards the control-runway element.

The control-runway element of an equipment-securing means according to the invention can be designed to be particularly space-saving if one guideway is configured as a free-running guideway and the other as a locking guideway, the free-running guideway having a directed unidirectional connection to the locking guideway and the locking guideway having a directed unidirectional connection to the arresting-element arresting position. It is immaterial which guideway lies inside or outside, provided that the control guideway lies between them. Within the context of the invention, a “directed unidirectional connection” is understood to be a connection—for example between different guideways of the control-runway element—which the arresting element cannot pass in any arbitrary direction during normal operation of the equipment-securing means, but only purposefully in one direction, whereas passage in the opposite direction is not possible for the arresting element.

According to a further advantageous embodiment of an equipment-securing means according to the invention, it can be provided that the arresting-element arresting position has a directed unidirectional connection to the control guideway, a preferred arrangement making the control guideway the unlocking-extension guideway. In the context of the invention, an unlocking-extension guideway is a control guideway along which the arresting element moves first after leaving the arresting-element arresting position before—if appropriate—passing into another guideway.

According to a further advantageous embodiment of an equipment-securing means according to the invention, it can be provided that the control guideway has a directed unidirectional connection to the free-running guideway.

According to a further advantageous embodiment of an equipment-securing means according to the invention—in which a particularly reliable transition between certain guideways can be ensured while a transition into selected guideways is deliberately blocked—it may be provided that the ramps that establish a directed unidirectional connection between the guideways each
have a ramp free-running side for the passage of the arresting element, in particular of the arresting-element pin of the arresting element, into another guideway, and
have a ramp locking side that blocks the arresting element, in particular the arresting-element pin of the arresting element, so as to block a transition of the arresting element into another guideway—in particular to block a transition of the arresting-element pin of the arresting element—along the edge of the ramp.

According to a further advantageous embodiment of an equipment-securing means according to the invention, it may be provided that the control guideway has, at one end—in particular at an unlocking-extension-guideway end, that is, at one end of the unlocking-extension guideway—an abutment, so that the arresting element, in particular the arresting-element pin of the arresting element, is blocked in the control guideway at this end.

According to a particularly compact embodiment of an equipment-securing means according to the invention, it can be provided that at least one of the guideways is of annular form and/or that the control guideway is in the form of an annular sector, in particular spanning a semicircle or three-quarter circle.

According to an advantageous variant of an equipment-securing means according to the invention, which makes it possible to lock the pulling element even while it is being rolled up, it can be provided that the arresting element can, during rewinding, be pushed from one of the guideways via a ramp into the control guideway and be brought back into the arresting-element arresting position when a pulling force directed away from the housing that is less than the force exerted on the reel by the restoring element again acts on the pulling element.

Furthermore, the invention also seeks to provide an equipment-securing means which, in the event of a shock load occurring, i.e. in the event of a fall or crash of a secured item of equipment, minimises or damps the forces that arise, and thus reduces or minimises the risk of injury to the user.

The invention solves this problem in an equipment-securing means for portable items of equipment, in particular portable tools, according to the preamble of claim 14.

According to the invention, it is provided that the pulling element, in the region of the end that is fixed to the reel, has at least one predetermined breaking connection for fall damping. The predetermined breaking connection is designed to absorb the pulling force when, after the pulling element has reached its end position, a pulling force directed away from the housing and exceeding a predefined force threshold value acts on the pulling element, dampening the fall accordingly.

By means of such a predetermined breaking connection a kind of damping element or damping effect is advantageously realised inside the housing of an equipment-securing means according to the invention, which—when an impact load occurs, that is, in the event of a fall of the secured item of equipment—minimises or damps the forces acting on the user, that is, the impact load that occurs. The predetermined breaking connection is preferably designed so that the force-threshold value is lower than the forces or impact loads that typically arise when items of equipment fall, so that the impact load is limited and the kinetic energy is absorbed or dissipated when the predetermined breaking connection ruptures or releases.

The absorption of forces can be made particularly reliable if several predetermined breaking connections are arranged one behind the other, in the winding direction of the pulling element, over a circumferential section of the reel, it being provided in particular that the predetermined breaking connections extend over at least 25% of one winding of the pulling element around the reel—and in particular over 50% to 300% of one winding.

One or more such predetermined breaking connections can be produced in a particularly simple and compact manner if the predetermined breaking connections are designed as a plurality of overlapping, interconnected pulling-element sections in the winding direction, the sections being joined to one another by sewing or gluing.

In such a design of a predetermined breaking connection, it is advantageously possible that, for example, the first rolled up section of the pulling element is joined—preferably sewn or bonded—in such a way that in the event of a shock load or in the event of the application of a force that exceeds the specified force threshold value, the overlapping, interconnected pulling-element sections are torn open or tear apart radially.

Such a design of a predetermined breaking connection or a damping element is particularly advantageous because it can be integrated in a highly space-saving manner within the housing of an extendable fall-protection device. Furthermore, the ease of manufacture and high reliability of the individual components should be emphasised. A further advantage over the prior art is the compact design, since the damping element is located inside the housing.

In this context, the predetermined breaking connection of an equipment-securing means according to the invention may provide that the force threshold value is the seam tear force or adhesive fracture force. In the context of the invention, the seam tear force or adhesive fracture force or tear-open force is understood to be the force required to tear apart two overlapping, interconnected pulling-element sections.

Depending on the type of connection of the pulling-element sections, this is the seam tear force for pulling-element sections that are sewn together or the adhesive fracture force for pulling-element sections that are glued together.

Further advantages and embodiments of the invention are shown in the description and the accompanying drawings.

The invention is illustrated schematically below, in the drawings, by particularly advantageous—though in no way limiting—exemplary embodiments and is described by way of example with reference to the drawings.

The accompanying drawings illustrate, schematically, the following:

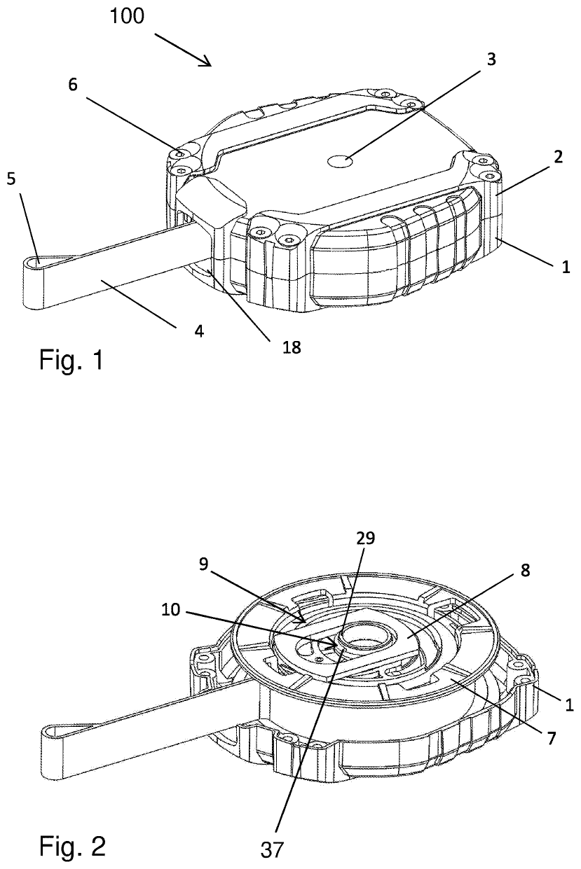

FIG. 1—a perspective view of an embodiment of the equipment-securing means according to the invention;

FIG. 2—a perspective view of the embodiment of FIG. 1 with the upper housing shell removed;

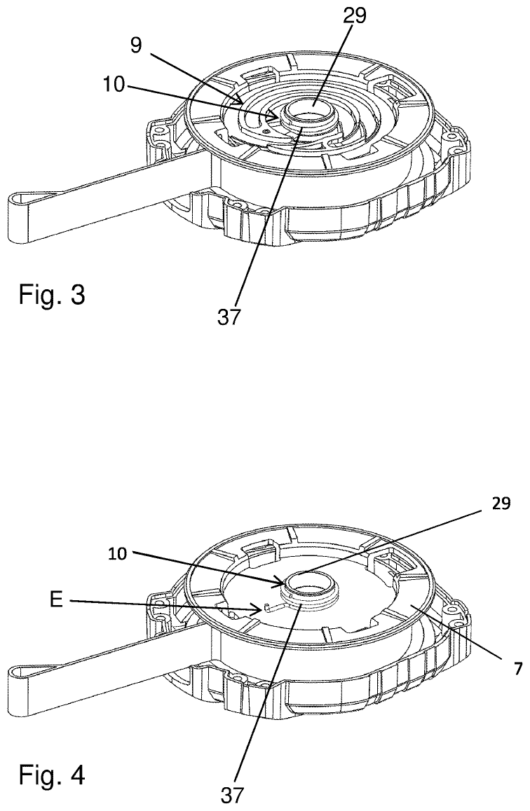

FIG. 3—a perspective view of the embodiment of FIG. 1 with the upper housing shell and the arresting element removed;

FIG. 4—a perspective view of the embodiment of FIG. 1 with the upper housing shell, the arresting element and the control-runway element removed;

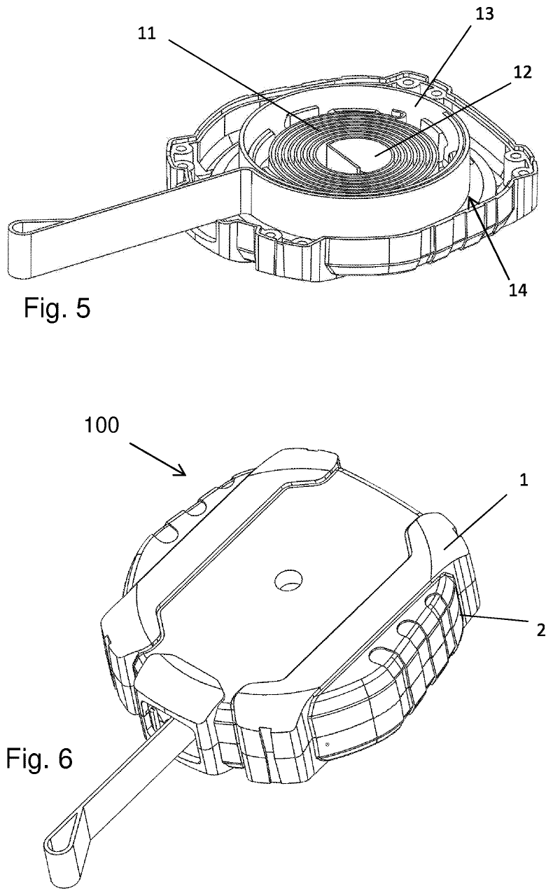

FIG. 5—a perspective view of the interior of the reel of the embodiment of FIG. 1 including the restoring element;

FIG. 6—a perspective view of the rear side of the embodiment of FIG. 1;

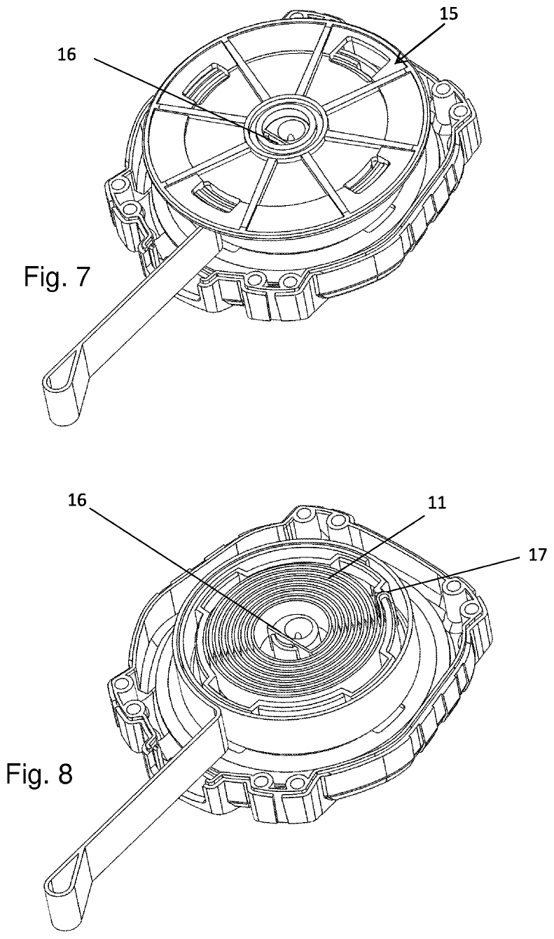

FIG. 7—a perspective rear view of the embodiment of FIG. 1 with the lower housing shell removed;

FIG. 8—a perspective rear view of the embodiment of FIG. 1 with the lower housing shell and the lower half of the reel removed;

FIG. 9—a perspective detail view of the reel together with the pulling element and the arresting mechanism of the embodiment of FIG. 1;

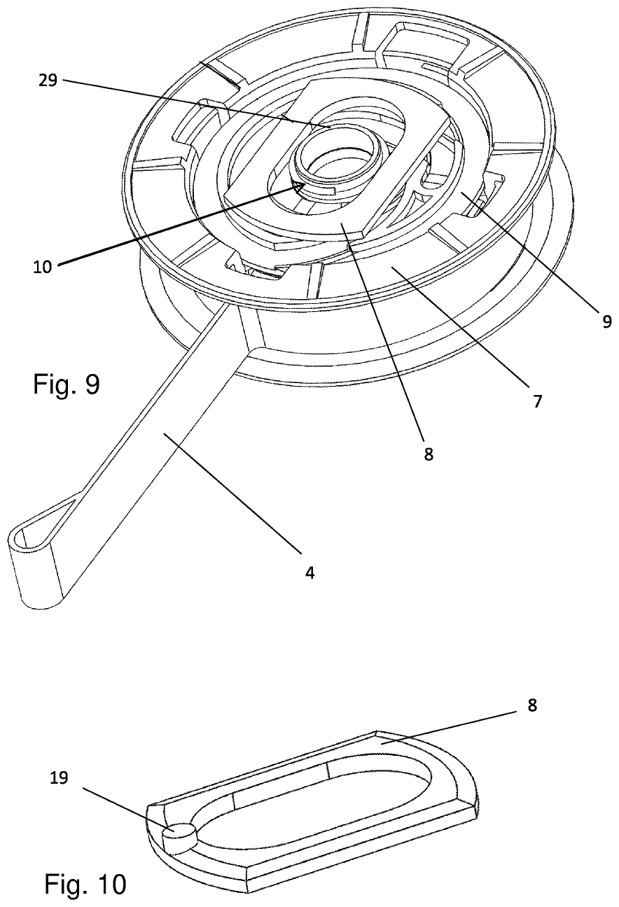

FIG. 10—a perspective detail view of the arresting element of the embodiment of FIG. 1;

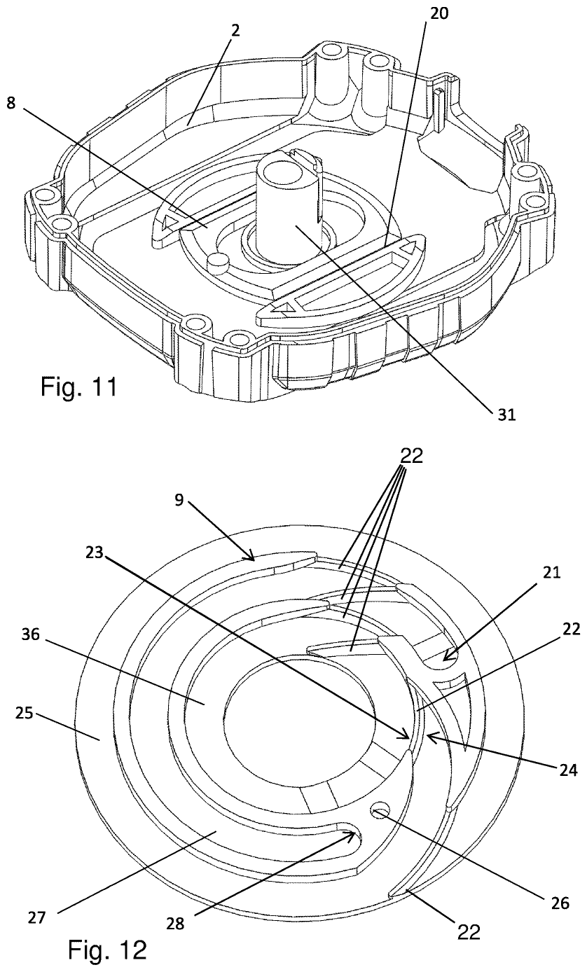

FIG. 11—a perspective detail view of the upper housing shell with the arresting element of the embodiment of FIG. 1;

FIG. 12—a perspective detail view of the control-runway element of the embodiment of FIG. 1;

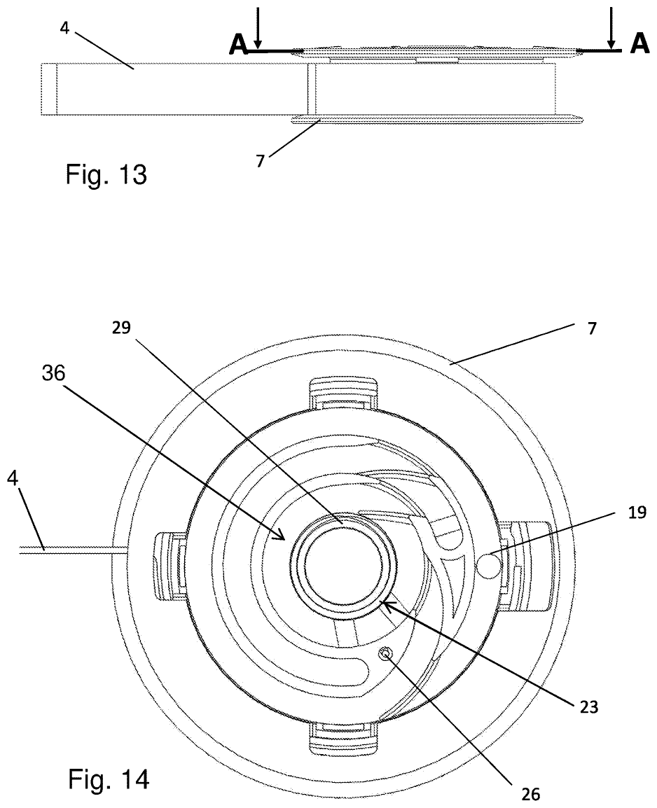

FIG. 13—a side view of the reel system and arresting mechanism of the embodiment of FIG. 1 with the cutting plane marked;

FIG. 14—section A-A of the embodiment of FIG. 13: arresting-element pin in the free-running guideway;

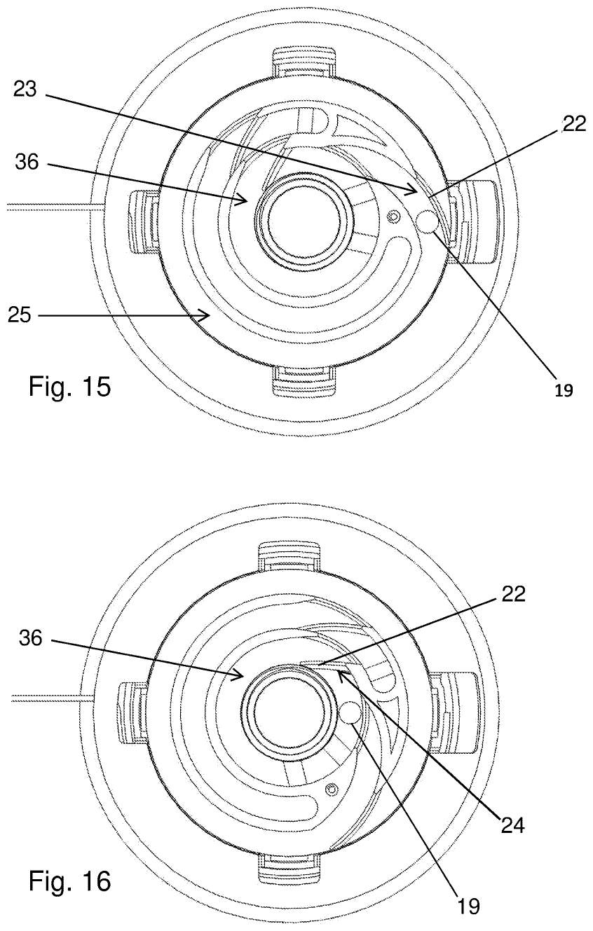

FIG. 15—section A-A of the embodiment of FIG. 13: arresting-element pin moving from the free-running guideway into the locking guideway;

FIG. 16—section A-A of the embodiment of FIG. 13: arresting-element pin in locking guideway 1;

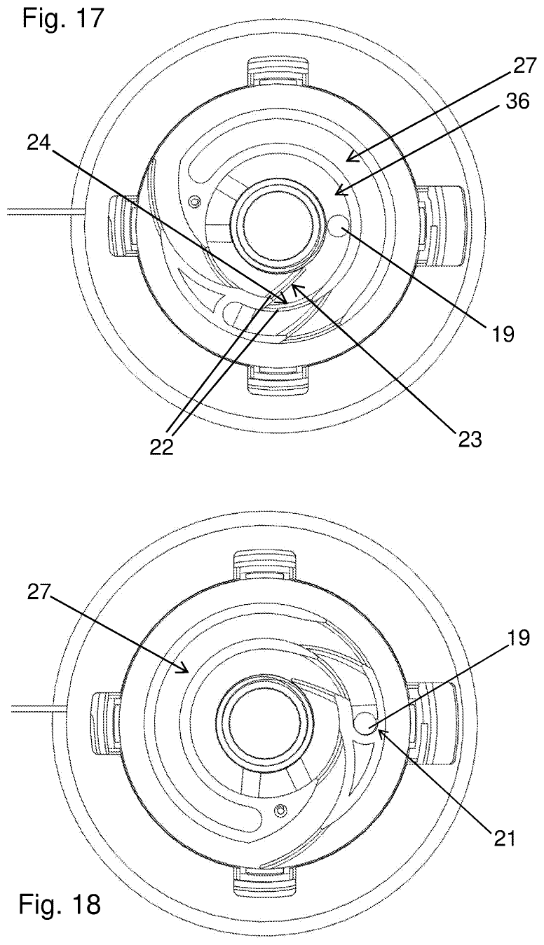

FIG. 17—section A-A of the embodiment of FIG. 13: arresting-element pin in locking guideway 2;

FIG. 18—section A-A of the embodiment of FIG. 13: arresting-element pin in the arresting-element arresting position;

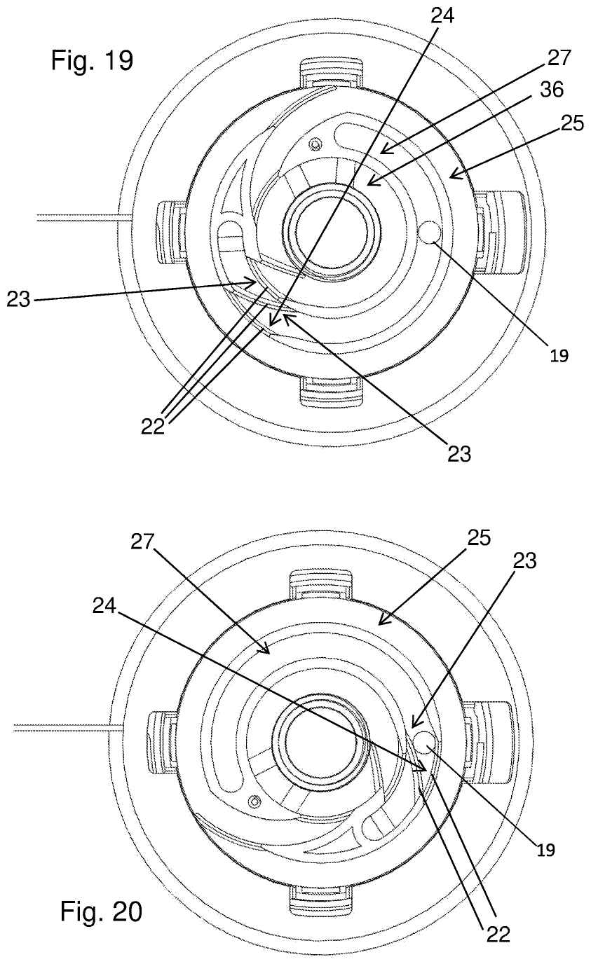

FIG. 19—section A-A of the embodiment of FIG. 13: arresting-element pin in the unlocking-extension guideway;

FIG. 20—section A-A of the embodiment of FIG. 13: arresting-element pin passing from the unlocking-extension guideway back into the free-running guideway;

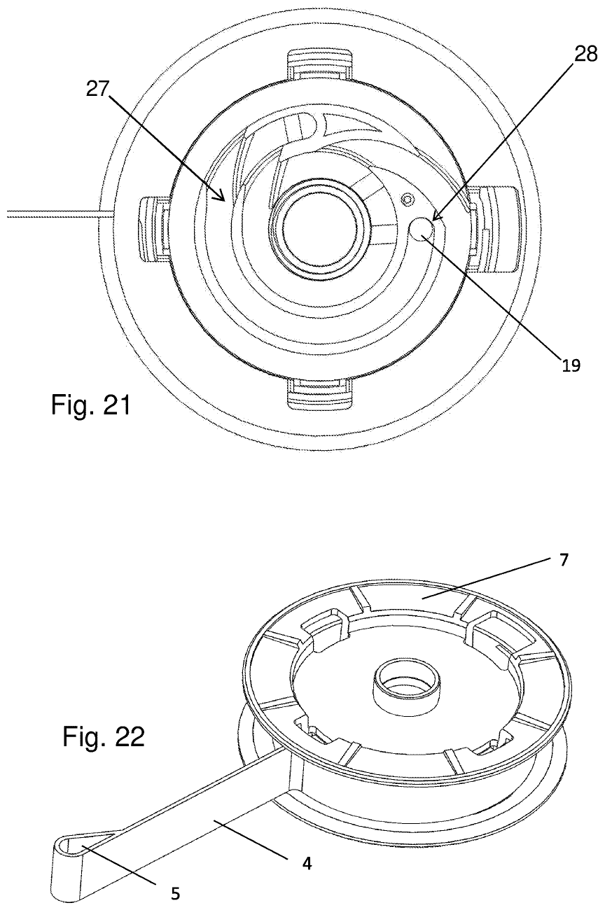

FIG. 21—section A-A of the embodiment of FIG. 13: arresting-element pin at the end of the unlocking-extension guideway;

FIG. 22—a perspective detail view of the reel system of the embodiment of FIG. 1 with the arresting mechanism removed;

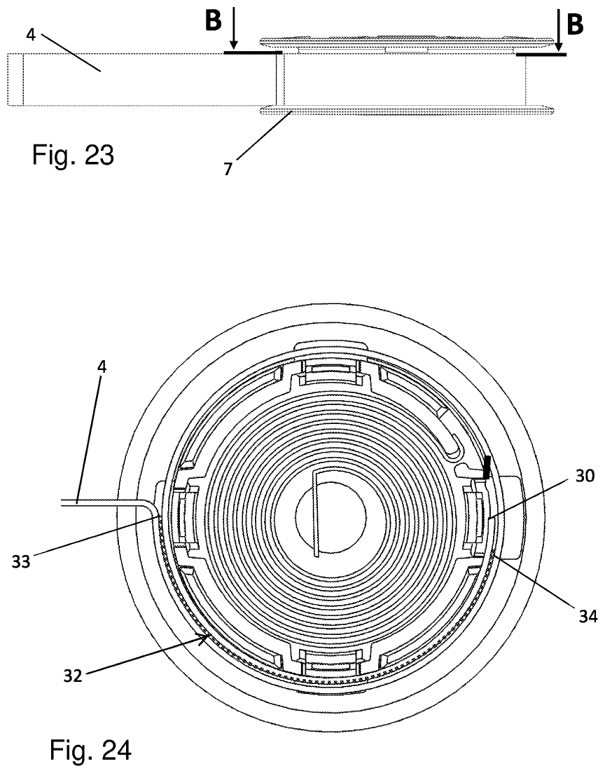

FIG. 23—a side view of the reel system of a second embodiment of the equipment-securing means without the arresting mechanism, with the cutting plane marked;

FIG. 24—section B-B according to FIG. 23 of the second embodiment: predetermined breaking connection-start of tearing;

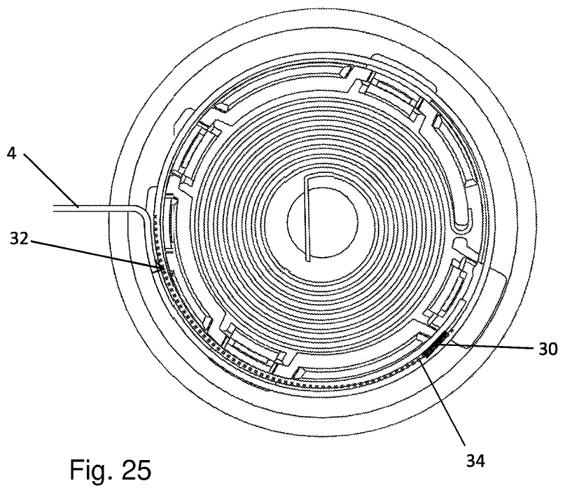

FIG. 25—section B-B according to FIG. 23 of the second embodiment: predetermined breaking connection-partial tearing;

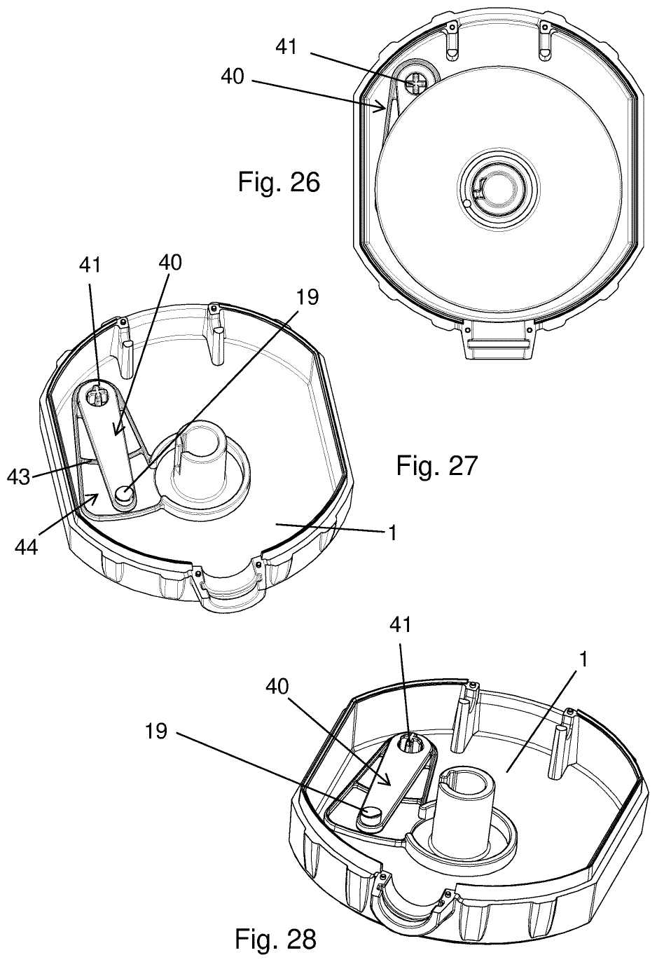

FIG. 26—a sectional view of a third embodiment of the equipment-securing means with the arresting element designed as a lever;

FIG. 27—a perspective detail view of a housing shell with the arresting element of the embodiment of FIG. 26;

FIG. 28—a second perspective detail view of a housing shell with the arresting element of the embodiment of FIG. 26;

FIG. 29—a first detail view of the embodiment of FIG. 26: arresting-element pin in the free-running guideway;

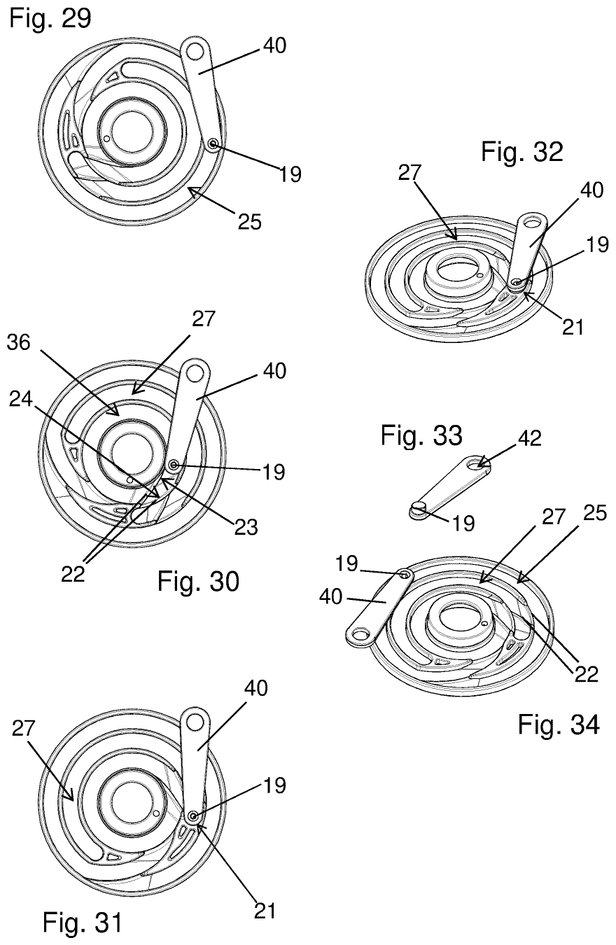

FIG. 30—a second detail view of the embodiment of FIG. 26: arresting-element pin in the locking guideway;

FIG. 31—a third detail view of the embodiment of FIG. 26: arresting-element pin in the arresting-element arresting position;

FIG. 32—a fourth detail view of the embodiment of FIG. 26: arresting-element pin (third detail view repeated);

FIG. 33—a detail view of the lever with the arresting-element pin of the embodiment of FIG. 26;

FIG. 34—a fifth detail view of the embodiment of FIG. 26: arresting-element pin in the free-running guideway;

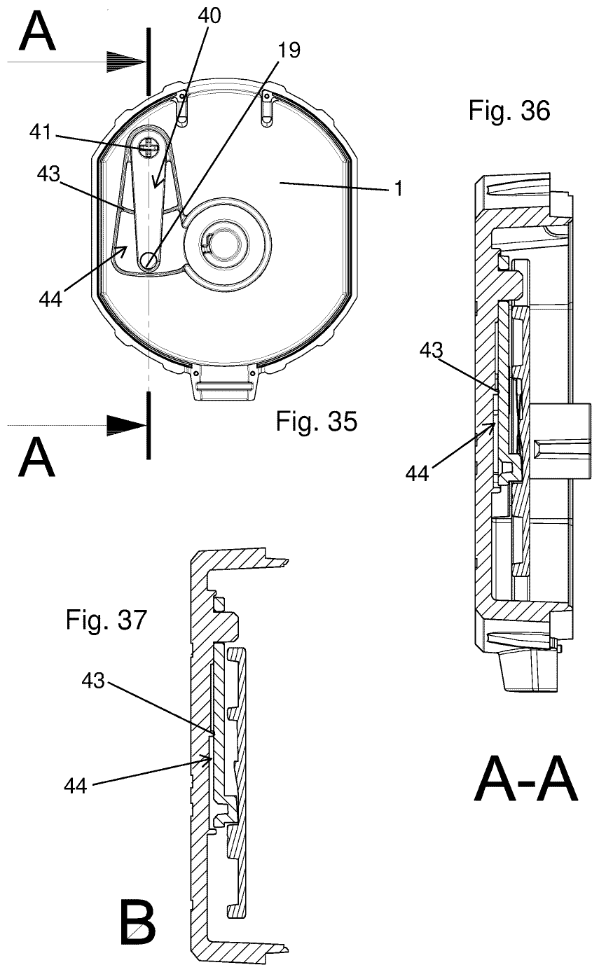

FIG. 35—a plan view of a housing shell with the arresting element of the embodiment of FIG. 26, cutting plane marked;

FIG. 36—a sectional view through the housing shell with the arresting element of FIG. 35;

FIG. 37—a detail of the sectional view of FIG. 36;

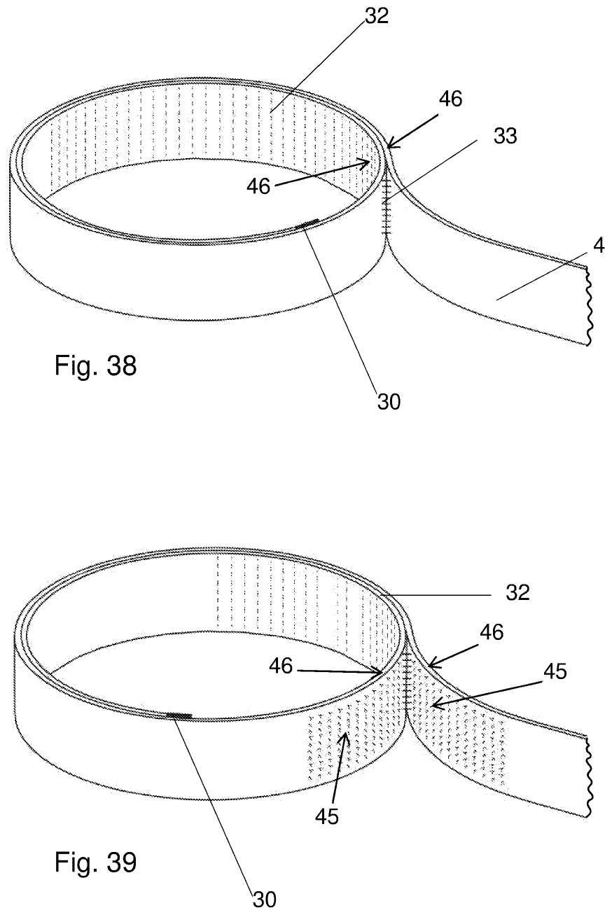

FIG. 38—a detail view of the predetermined breaking connections of the second embodiment of FIG. 23 shortly before tearing starts;

FIG. 39—a detail view of the partially destroyed predetermined breaking connections of the second embodiment of FIG. 23.

FIG. 1 to FIG. 25 show various views of a first embodiment example of an equipment-securing means 100 according to the invention for items of equipment such as hand-held devices. In the first embodiment example, the equipment-securing means 100 includes a runway-type arresting mechanism and the predetermined breaking connection (damping element) according to the invention, which are described in more detail below. However, it is of course also possible for an equipment-securing means 100 according to the invention to be designed only with an arresting mechanism and without a predetermined breaking connection, or for a predetermined breaking connection to be incorporated in a fall-protection device known from the prior art.

As in the embodiment example (see in particular FIG. 1, FIG. 6), an equipment-securing means 100 according to the invention comprises a pulling element 4 which may optionally carry a pulling-element connecting element 5 at its end protruding from the housing. The equipment to be secured can be attached or mounted to the pulling element 4 at the pulling-element connecting element 5.

In the embodiment example (see in particular FIGS. 1, 5, 7 and 8), the equipment-securing means 100 comprises a housing, a reel 7, and a restoring element 11. In the first embodiment example, the housing comprises two housing shells 1, 2, which can be glued, screwed or otherwise joined together by means of a housing-connecting element 6. A through-hole 3 can be made in the centre of the two housing shells 1, 2 in order to attach the equipment-securing means 100 to the body or to a rigid structure. However, any other form of attachment is also possible.

FIG. 2 shows the opened housing with the reel 7 and an example of the arresting mechanism according to the invention, the mode of operation of which is explained in detail below. The reel 7 is mounted rotatably in the housing, namely in housing shell 1. When retracted, the pulling element 4 is rolled up onto the reel 7. A control-runway element 9 is mounted rotatably in the reel 7.

The control-runway element 9 is connected to the reel 7 by a freewheel element 10 and possesses two concentrically extending guideways spaced radially from one another together with a control guideway 27 extending concentrically between them, and ramps 22 arranged between the individual ways. The control guideway 27 contains the arresting-element arresting position 21.

An arresting element 8 engages in the control-runway element 9, which is guided in the guideways and in the control guideway 27 and/or along the ramps 22 of the control-runway element 9; this will be discussed in detail further below.

In FIG. 3 the reel 7 is shown in the first housing shell 1 together with the control-runway element 9 and the freewheel element 10 but without the arresting element 8. FIG. 4 shows the freewheel element 10 of the first embodiment in detail.

In the first embodiment the freewheel element 10 is a leg spring 37 wound onto an encircling pin 29 and connected, at an end E—that is, at one leg—to the control-runway element 9 (see FIGS. 2, 3, 4). This arrangement advantageously allows the control-runway element 9 to rotate in only one rotational direction: in the free-running direction the freewheel element 10, i.e. the leg spring 37, releases the rotation, whereas in the locking direction the freewheel element 10 blocks the control-runway element 9. In the embodiment the freewheel element 10 is realised as a leg spring whose encirclement around the encircling pin 29 increases the encircling force in the locking direction—and hence the frictional force—to such an extent that further rotation is impossible.

Any other type of freewheel element 10 is, however, also conceivable. The freewheel element 10 can moreover be designed so that even in the free-running direction a minimal counter-acting force is produced, which is achieved in particular by employing a leg spring 37.

FIGS. 5 and 8 show the restoring element 11 in the housing, that is in the first housing shell 1. The reel 7 is mounted so that it can rotate relative to the housing and the first housing shell 1, for example via a radial bearing formed on the inside of the housing. The inner end 12 of the restoring element and the inner end 13 of the pulling element are likewise shown in FIG. 5. FIG. 8 shows the restoring-element end 17.

The pulling element 4, one end of which, to which the pulling-element connecting element 5 is attached, protrudes from the housing and is used to attach items, is fully rolled up on the reel 7 in the starting state. In the illustrated embodiment, the pulling element 4 is rolled up on the outer periphery of the reel 7. A housing recess 18 through which the pulling element 4 can project is visible in FIG. 1.

The restoring element 11 is arranged between the housing and the reel 7 and exerts a tensile force on the reel 7 such that, in the starting state, the pulling element 4 is rolled up on the reel 7. In the embodiment the restoring element 11 is a spiral spring fixed on the bearing supporting the reel 7 on the one hand and on the inside wall of the reel 7 on the other. However, the restoring element 11 need not be a spiral spring; it can also be a torsion spring or any other restoring element known from the prior art, for example. The restoring-element attachment 16 is visible in FIGS. 7 and 8.

Due to the action of the force exerted by the restoring element 11 on the reel 7, the pulling element 4 is automatically at least partially rolled up, e.g. on the outer periphery of the reel 7, when a pulling force acts on the pulling element 4 which is smaller than the force exerted by the restoring element 11 on the reel 7. In the context of the invention, the term “starting state” is understood to mean that the pulling element 4 is fully rolled up on the reel 7 and only one end of the pulling element 4 protrudes from the housing.

If a pulling force directed away from the housing and greater than the force exerted on the reel 7 by the restoring element 11 acts on the pulling element 4, the pulling element 4 can be unrolled up to an end position and drawn out of the housing. In the context of the invention, the term “end position” is understood to mean that the pulling element 4 is completely unrolled from the reel 7 and drawn out of the housing, so that only the end of the pulling element 4 rests on or against the reel 7 or, for example, only a small part of the pulling element 4 fully or partially wraps around the reel 7.

To ensure that no restoring-element tensile force acts on an item of equipment attached to the pulling element 4 when the item is in use by the user and the pulling element 4 is not in the starting state, the equipment-securing means 100 according to the invention includes an arresting mechanism that can lock the pulling element 4, or the cable, in any desired extension position. It is then unlocked by a further pull of any desired length on the pulling element 4, or the cable. An embodiment example of such an arresting mechanism according to the invention is shown in FIG. 9 to FIG. 21.

In principle, the mode of functioning of an equipment-securing means 100 according to the invention is as follows: the guideways, the control guideway 27 and the ramps 22 are designed and arranged relative to one another such that, by pulling on the pulling element 4 with a force greater than the force exerted on the reel 7 by the restoring element 11, the pulling element 4 can be pulled out of the housing 1 and the arresting element 8 can move freely in one of the guideways, so that the control-runway element 9 rotates together with the reel 7.

If a pulling force directed away from the housing that is less than the force exerted on the reel 7 by the restoring element 11 acts on the pulling element 4, the pulling element 4 is retracted into the housing by the restoring element 11 and the arresting element 8 is pushed from one of the guideways via one of the ramps 22 into the control guideway 27. In this way the arresting element 8 reaches the arresting-element arresting position 21 of the control guideway 27, so that rotation of the reel 7 relative to the housing is blocked.

When the arresting element 8 is located outside the arresting-element arresting position 21, the reel 7 can be rotated relative to the housing.

If a pulling force directed away from the housing that is greater than the force exerted on the reel 7 by the restoring element 11 acts on the pulling element 4, the arresting element 8 is guided out of the arresting-element arresting position 21 via one of the ramps 22 onto the control guideway 27 or one of the guideways, and the pulling element 4 can be pulled out or rolled up.

In FIG. 9 the reel system of the embodiment of FIG. 1 is shown, i.e. the reel 7 together with the pulling element 4, the control-runway element 9 and the arresting element 8. FIG. 9 illustrates the components of the arresting mechanism. The reel 7 can, but need not, consist of two parts, namely a lower reel shell 14 and an upper reel shell 15 (see FIGS. 5 and 7). In the embodiment the control-runway element 9 is mounted rotatably, by way of a radial bearing, in the reel 7 or in the housing. The arresting element 8 is arranged or installed on the control-runway element 9.

FIG. 10 shows the arresting element 8 in detail. In the embodiment example, the arresting element 8 is slider-shaped and has a pin, the arresting-element pin 19. This pin engages in the control-runway element 9 and is guided in its ways. Guidance in the ways causes the arresting element 8 to shift along an axis, which in the embodiment example is designed in the housing.

FIG. 11 shows an example of a possible implementation of such a guidance system. As can be seen in FIG. 11, the arresting element 8 is guided on the side surfaces 20 in the housing or the housing shell 1. This means that the arresting element 8 can only move along one axis. The axis running surface 31 can also be seen.

As shown in FIGS. 4 and 9 and described above, the freewheel element 10—here a leg spring 37—is wound on the encircling pin 29 and is connected at one leg to the control-runway element 9. The connection to the control-runway element 9 can be implemented, for example, by a connection point 26, as shown in FIG. 12. This arrangement allows the control-runway element 9 to rotate only in one direction. In the free-running direction the freewheel element 10 releases the rotation; in the locking direction the freewheel element 10 blocks the control-runway element 9.

FIGS. 12 to 17 show detailed views of a preferred embodiment of the control-runway element 9 according to the invention. As previously mentioned, the control-runway element 9 comprises several ways 25, 27, 36 according to the invention, which achieve the desired effect by means of the interconnection according to the invention, namely the locking of the restoring force in any desired extension position and the renewed unlocking by a pull of any desired length on the pulling element 4.

According to the invention, the control-runway element 9 comprises two concentrically extending guideways spaced radially apart—in the embodiment example, annular-sector-shaped or almost annular—namely a free-running guideway 25 and a locking guideway 36, and between them, concentrically arranged, an annular-sector-shaped control guideway 27, referred to below, because of its function, as the unlocking-extension guideway. The control guideway 27 has an arresting-element arresting position 21, and the individual ways 25, 27, 36 are separated by ramps 22 (FIG. 12).

In the embodiment example, the arresting-element pin 19 enters the different ways 25, 27, 36 of the control-runway element 9. The free-running guideway 25 has a one-way connection, i.e. a directed unidirectional connection, to the locking guideway 36. The locking guideway 36 has a directed unidirectional connection to the arresting-element arresting position 21. The arresting-element arresting position 21 leads into the unlocking-extension guideway, i.e. the control guideway 27. The ramps 22 between the ways 25, 27, 36 are shaped so that the arresting-element pin 19 enters and runs only in the intended ways. Each directed unidirectional connection is formed by a ramp 22 that has a ramp free-running side 24, which the arresting element 8 or its pin 19 can traverse, and a ramp locking side 23, which blocks the arresting element 8 or its pin 19.

The ramps 22 therefore have a ramp free-running side 24 enabling the arresting-element pin 19 or the arresting element 8 to slide over the ramp 22, and a ramp locking side 23 that is always designed in such a way that it prevents the arresting-element pin 19 or the arresting element 8 from sliding over the ramp 22 and instead guides it along the ramp edge. The end of the unlocking-extension guideway 28 is likewise designed so that the arresting-element pin 19 cannot slide over a ramp 22 there but is retained at the unlocking-extension guideway end 28.

The freewheel element 10, that is one leg of the leg spring 37, is, as stated, fixed to the control-runway element 9 at one end (FIG. 12).

FIG. 13 shows the side view of the reel system together with the arresting mechanism of the embodiment of FIG. 9 and at the same time shows the plane on which the section is made for the sectional views in FIG. 14 to FIG. 21.

FIG. 14 shows the retracted position, i.e. the starting state, in which the pulling element 4 is fully rolled up onto the reel 7. The arresting-element pin 19 can be seen in the sectional view and is located in the free-running guideway 25. The arresting-element pin 19 is part of the arresting element 8 and, as can be seen in FIG. 11, is guided on the side surfaces 20 in the housing and can therefore only move in one direction.

If the pulling element 4 is now pulled out, the reel 7 rotates in an anticlockwise direction accordingly. However, an equipment-securing means 100 according to the invention or its arresting mechanism can of course also be constructed in a mirror-inverted manner with respect to the embodiments shown in FIGS. 1 to 37 so that, for example, the rotation of the reel 7 can also be clockwise.

The control-runway element 9 also follows the rotational movement of the reel 7, as the freewheel element 10 or the leg spring 37 opposes a small force, also in the free-running direction, which is greater than the frictional force of the adjacent arresting-element pin 19. When the pulling element 4 is pulled out, the arresting-element pin 19 reaches the ramp locking side 23 of the ramp 22 between the free-running guideway 25 and the locking guideway 36, which guides the arresting-element pin 19 further along the edge into the locking guideway 36 (see FIG. 15). The pulling element 4 can be partially or fully extended. The arresting-element pin 19 is always located in the locking guideway 36. If it now reaches the ramp free-running side 24 of the ramp 22 within the locking guideway 36 during the pull-out process (see FIG. 16), it can easily slide over the ramp 22.

If the pulling force on the pulling element 4 is then reduced so that it is less than the force exerted by the restoring element 11, causing the pulling element 4 to retract, the arresting-element pin 19 is guided along the ramp locking side 23 of the ramp 22 inside the locking guideway 36 (FIG. 17) from the locking guideway 36 into the arresting-element arresting position 21. In the process, a further ramp free-running side 24 of the ramp 22 is also overcome between the locking guideway 36 and the control guideway 27.

In FIG. 18, the arresting-element pin 19 is in the arresting-element arresting position 21 of the control guideway 27. The pull on the pulling element 4 is now locked and the user feels no interfering pull on the pulling element 4. They can now use the secured equipment without restriction.

If the user pulls on the pulling element 4 again, the arresting-element pin 19 is guided from a ramp locking side 23 of the ramp 22 between the locking guideway 36 and the control guideway 27 onto the control guideway 27, whereby the arresting-element pin 19 slides over a ramp free-running side 24 of the ramp 22 within the control guideway 27. The arresting-element pin 19 is then guided along the control guideway 27, i.e. the unlocking-extension guideway (see FIG. 19). If the renewed pull on the pulling element 4 is only long enough for the arresting-element pin 19 to remain within the control guideway 27 or the unlocking-extension guideway, and the pulling element 4 is rolled up again on the reel 7, the arresting-element pin 19 is guided back onto the free-running guideway 25 via a ramp locking side 23 of the ramp 22 within the control guideway 27 and via a ramp free-running side 24 of the ramp 22 between the control guideway 27 and the free-running guideway 25, and the pulling element 4 can wind up again on the reel 7 if, after the renewed pull, the pull-out force, i.e. the force exerted on the pulling element 4, is subsequently reduced, i.e. the pulling force exerted on the pulling element 4 and directed away from the housing is less than the restoring force of the restoring element 11.

However, if the pulling element 4 is pulled out from the arresting-element arresting position 21 until the arresting-element pin 19 reaches the unlocking-extension guideway end 28, i.e. the end of the control guideway 27 that has a stop, the arresting-element pin 19 presses on the unlocking-extension guideway end 28 and exerts a force. If this force is greater than the force required to turn the freewheel element 10 in its free-running direction, the pulling element 4 can be pulled out as long as desired, but at most to full extension or to the end position of the pulling element 4.

If the pulling force on the pulling element 4 is then reduced at any point selected by the user so that the restoring force of the restoring element 11 winds the pulling element 4 back onto the reel 7, the arresting-element pin 19 is guided back onto the free-running guideway 25 via the ramp locking side 23 of the ramp 22 within the control guideway 27 and the ramp free-running side 24 of the ramp 22 between the control guideway 27 and the free-running guideway 25 (see FIG. 20).

The locking guideway 36, free-running guideway 25 and control guideway 27 can be arranged in any desired manner within the scope of the invention, as long as the guideways 25, 27, 36 are interconnected in accordance with the invention. For example, the locking guideway 36 can also be on the outside and the free-running guideway 25 in the more inner part of the control-runway element 9.

FIG. 22 shows the reel system with the arresting mechanism components removed. The pulling element 4 is rolled up onto the reel 7.

### Sequence of Use

The use of an extendable equipment-securing means 100 according to the invention for hand-held devices with a runway-style arresting mechanism can be carried out as follows:
Equipment is attached to the pulling element 4 and the equipment-securing means 100 is attached to the user's body or to a rigid structure.
The pulling element 4 is fully rolled up onto the reel 7 inside the housing.
The user pulls on the equipment, the pulling element 4 unwinds and the arresting-element pin 19 is guided from the free-running guideway 25 into the locking guideway 36.
The user reaches the desired extension position.
The user keeps the equipment in their hand but no longer exerts any pulling force. The arresting-element pin 19 is guided by the locking guideway 36 into the arresting-element arresting position 21. The reel 7 is locked against rotation by the restoring element 11, and the pulling element 4 is partially or fully unrolled. The secured equipment can then be used without restriction, i.e. without interfering tension on the pulling element 4.
The user wishes to retract the pulling element 4: They exert a pulling force on the pulling element 4 and pull out the pulling element 4 to the length desired, but no longer than the full extension.
The arresting-element pin 19 is guided along the control guideway 27, which thus serves as an unlocking-extension guideway.
If the user pulls out the pulling element 4 to the extent that the unlocking-extension guideway end 28, i.e. the end of the control guideway 27 that has a stop, is not reached, the arresting-element pin 19 is guided back into the free-running guideway 25.
If the user pulls out the pulling element 4 so far that the unlocking-extension guideway end 28 is reached, the arresting-element pin 19 makes contact against the unlocking-extension guideway end 28, the freewheel element 10 releases the rotation of the control-runway element 9 and the user can continue to pull out the pulling element 4 as desired, but no longer than the full extension. As soon as the user no longer exerts any force, the arresting-element pin 19 is guided into the free-running guideway 25.
In both of the above cases, the pulling element 4 is then rolled up again, as the arresting-element pin 19 is located in the free-running guideway 25.

FIG. 23, FIG. 24, FIG. 25, FIG. 38 and FIG. 39 show a second embodiment example of an equipment-securing means 100 according to the invention with a predetermined breaking connection 32 or a damping element in order to minimise the fall of an item of equipment fixed to the pulling element 4 and the peak impact load resulting from the fall or the forces acting on the user. FIG. 23 shows the side view of the reel system without arresting mechanism elements and the position of the sectional views in FIG. 24 and FIG. 25.

In general, the equipment-securing means in the second embodiment example has the same structure as described in the first embodiment example, as well as, in addition, at least one predetermined breaking connection 32 in the region of that end of the pulling element 4 which is attached to the reel 7.

When a pulling force directed away from the housing and exceeding a predefined force threshold acts on the pulling element 4 after the pulling element 4 has reached the end position, the predetermined breaking connection 32—or the predetermined breaking connections 32—absorb(s) the tensile force and thus damp(s) the fall of the item of equipment.

In FIG. 24, the pulling element 4 is almost completely unrolled from the reel 7. The end of the pulling element 4 is fixed at a fixing point 30 on the reel 7 and is only partially rolled up around the circumference of the reel 7. At the point at which the pulling element 4 reaches a part of the already rolled-up pulling-element section for the first time, several predetermined breaking connections 32 or the damping connecting element are designed in such a way that they connect the overlapping pulling-element sections 46 (see FIG. 38 and FIG. 39). This connection can preferably be implemented by a seam or bond 34, as in the second embodiment example. In this case, the force threshold that the pulling force acting on the pulling element 4 away from the housing must exceed in order to destroy the predetermined breaking connections 32 is the seam tear force or the adhesive fracture force.

FIG. 38 and FIG. 39 show the pulling element 4 with the overlapping pulling-element sections 46, which are connected by predetermined breaking connections 32, once again in detail and without reel 7. FIG. 38 shows the pulling element 4 almost completely unrolled and the tearing-start point 33 is visible.

In FIG. 39, the predetermined breaking connections 32 between the overlapping pulling-element sections 46 are already partially destroyed and the destroyed seams or bonding 34 can be seen in a seam-destruction region 45. It can also be seen in FIG. 39 that the seam or bonding 34 of the predetermined breaking connections 32 is still intact in an area following the seam-destruction region 45.

Other forms of predetermined breaking connections or damping connecting elements are also conceivable.

In the embodiment example, the predetermined breaking connections 32 extend in series in the winding direction of the pulling element 4, over a circumferential section of the reel 7 over 50% of a winding around the reel 7. However, shorter circumferential sections or a series of predetermined breaking connections 32 over several windings are also possible.

The predetermined breaking connections 32, or the damping connecting element, are designed in such a way that the peak impact load is limited in the event of a fall. The predetermined breaking connections 32, or the damping connecting element, are destroyed until the overlapping pulling-element sections have completely separated from each other. The impact energy is dissipated by destroying the predetermined breaking connections 32 or the connection element.

In the event of a fall, the predetermined breaking connections 32, or the damping connecting element, are destroyed piece by piece starting from the tearing-start point 33 and, as a result, the connected, overlapping pulling-element sections separate from each other. This is shown in FIG. 25, where some of the predetermined breaking connections 32 have already been destroyed. Such predetermined breaking connections 32 can be made in any number desired along the circumference; multi-layer overlapping pulling-element sections connected by one or more predetermined breaking connections 32 are also conceivable.

FIGS. 26-37 show a third embodiment of an equipment-securing means 100 according to the invention with an arresting element 8 in the form of a lever 40.

Apart from the specific design of the arresting element 8, the equipment-securing means 100 in the third embodiment example has the same structure as described in the first embodiment example. In the third embodiment example, the arresting element 8 is designed as a lever 40, which is arranged on the housing and extends in the direction of the control-runway element 9.

FIG. 26 shows the arrangement of the pivot point 41 of the lever 40 of the arresting element 8, which is designed as a cross in FIG. 26. The pivot point 41 is positioned particularly favourably in the embodiment example, as it is positioned outside the control-runway element 9. A cross-shaped design of the pivot point 41 is also particularly advantageous, as this shape can be easily produced by injection moulding without component distortion. Alternatively, the pivot point 41 can of course also be designed as a cylinder. The only decisive factor is that the lever 40 must be able to pivot around the pivot point 41.

FIG. 27 and FIG. 28 show views of the lever 40 with arresting-element pin 19 in the housing, specifically in the lower housing shell 1. In order to be able to compensate for the height difference when passing the individual ramps 22, a recess 44 is provided in the housing in the embodiment example. The lever 40 can thus compensate for the height via a tilting edge 43. It is particularly advantageous if the lever 40 is slightly flexible, as can be achieved by manufacturing it from plastic, for example. However, the height compensation due to the ramps 22 can also be achieved with a rigid lever through the recess 44 and tilting edge 43.

FIGS. 29 to 34 show the arresting element 8, designed as a lever 40, in the same positions or states as already described in FIGS. 14 to 21. Therefore, only a brief description of the individual figures is given here, and reference is made to the description of the figures in FIGS. 14 to 21 above for a more detailed description.

FIG. 29 shows the retracted position or the starting state of the pulling element 4, which is fully rolled up on the reel 7. The arresting-element pin 19 is located in the free-running guideway 25.

When the pulling element 4 is pulled out, the arresting-element pin 19 comes to the ramp locking side 23 of the ramp 22 between the free-running guideway 25 and the locking guideway 36, which guides the arresting-element pin 19 along the edge into the locking guideway 36. The pulling element 4 can be partially or fully extended. The arresting-element pin 19 is always located in the locking guideway 36.

When, during extension, the pin reaches the ramp free-running side 24 of the ramp 22 within the locking guideway 36, it can simply slide over the ramp 22.

If the pulling force on the pulling element 4 is now reduced so that the force is less than the force exerted by the restoring element 11, resulting in the pulling element 4 being rolled up again, the arresting-element pin 19 is guided along the ramp locking side 23 of the ramp 22 within the locking guideway 36 (see FIG. 30), from the locking guideway 36 into the arresting-element arresting position 21. In the process, a further ramp free-running side 24 of the ramp 22 is also overcome between the locking guideway 36 and the control guideway 27.

In FIG. 31 and FIG. 32, the arresting-element pin 19 is in the arresting-element arresting position 21 of the control guideway 27. The pull on the pulling element 4 is now locked and the user feels no interfering pull on the pulling element 4. They can now use the secured equipment without restriction.

If the user pulls on the pulling element 4 again, the arresting-element pin 19 is guided from a ramp locking side 23 of the ramp 22 between the locking guideway 36 and the control guideway 27 onto the control guideway 27, whereby the arresting-element pin 19 slides over a ramp free-running side 24 of the ramp 22 within the control guideway 27. The arresting-element pin 19 is then guided along the control guideway 27, i.e. the unlocking-extension guideway. If the renewed pull on the pulling element 4 is only long enough for the arresting-element pin 19 to remain within the control guideway 27, and the pulling element 4 is rolled up again on the reel 7, the arresting-element pin 19 is guided back onto the free-running guideway 25 via a ramp locking side 23 of the ramp 22 within the control guideway 27 and via a ramp free-running side 24 of the ramp 22 between the control guideway 27 and the free-running guideway 25, into the free-running guideway 25, and the pulling element 4 can be rolled up again on the reel 7.

However, if the pulling element 4 is pulled out from the arresting-element arresting position 21 until the arresting-element pin 19 reaches the unlocking-extension guideway end 28, the arresting-element pin 19 presses on the unlocking-extension guideway end 28 and exerts a force. If this force is greater than the force required to rotate the freewheel element 10 in its free-running direction, the pulling element 4 can be pulled out to any desired length, but at most to the full extension or to the end position of the pulling element 4.

If the pulling force on the pulling element 4 is now reduced at any point selected by the user so that the restoring force of the restoring element 11 winds the pulling element 4 back onto the reel 7, the arresting-element pin 19 is guided back onto the free-running guideway 25 via the ramp locking side 23 of the ramp 22 within the control guideway 27 and the ramp free-running side 24 of the ramp 22 between the control guideway 27 and the free-running guideway 25 (see FIG. 34).

FIG. 33 shows a detailed view of the lever 40 from the third embodiment example. Like the slider-type arresting element 8 from the first embodiment example, this has an arresting-element pin 19, which is guided in the guideways 25, 27, 36 of the control-runway element 9. A connecting element is provided on the side of the lever 40 opposite the arresting-element pin 19, which enables the lever 40 to be mounted in a pivotable manner in the housing. In the third embodiment example, the connecting element is a circular opening 42 in the lever 40, so that the lever 40 can be fitted onto the pivot 41 and the lever 40 is thus mounted on the housing in a pivotable manner. However, other types of connecting elements that allow the lever 40 to rotate about an axis relative to the housing are also conceivable.

The sectional views FIGS. 35 to 37 show the mounting of the lever 40 in the housing and how the lever 40 engages in the guideways 25, 27, 36 of the control-runway element 9. FIG. 36 and FIG. 37 also show the tilting edge 43 and the clearance for the tilting movement, i.e. the recess 44.

What is claimed is:

1. An equipment-securing means (100) for portable items of equipment, in particular portable tools, comprising:
a housing in which a reel (7) and a restoring element (11) are arranged, wherein the reel (7) is mounted in the housing so that it can rotate relative thereto,
a pulling element (4) for fastening items of equipment, wherein the pulling element (4) is fully rolled up on the reel (7) in a starting state and one end of the pulling element (4) protrudes from the housing,
wherein the restoring element (11) is arranged between the housing and the reel (7) in such a way that the restoring element (11) exerts a tensile force on the reel (7) in the direction of an interior of the housing, so that the pulling element (4) can be rolled up onto the reel (7),
wherein the pulling element (4), when a pulling force directed away from the housing acts on the pulling element (4) which is greater than the force exerted on the reel (7) by the restoring element (11), can be unrolled to an end position in which the pulling element (4) is completely unrolled from the reel (7) and can be pulled out of the housing, and
wherein the pulling element (4), when a pulling force directed away from the housing acts on the pulling element (4) which is smaller than the force exerted on the reel (7) by the restoring element

(11) can be rolled up onto the reel (7) until the starting state and can be retracted into the housing,
characterised by:
an arresting mechanism comprising:
a control-runway element (9) that is connected to the reel (7) via a freewheel (10) and has two concentrically extending guideways spaced radially apart, of annular or annular-sector form, and a control guideway (27) extending concentrically between them, likewise of annular or annular-sector form, the control guideway (27) having an arresting-element arresting position (21) and ramps (22) being arranged between the individual guideways, and
an arresting element (8) that engages in the control-runway element (9) and is guided in the guideways and the control guideway (27) and/or along the ramps (22) of the control-runway element (9), and
wherein the guideways, the control guideway (27) and the ramps (22) are designed and arranged relative to one another so that by pulling on the pulling element (4) with a force which is greater than the force exerted by the restoring element (11) on the reel (7), the pulling element (4) can be pulled out of the housing and the arresting element (8) can be guided freely in one of the guideways, so that the control-runway element (9) rotates with the reel (7), so that when a pulling force directed away from the housing acts on the pulling element (4), which force is smaller than the force exerted by the restoring element (11) on the reel (7), the pulling element (4) can be pulled back into the housing by the restoring element (11) and the arresting element (8) can be guided freely in one of the guideways via one of the ramps (22) into the control guideway (27), the pulling element (4) can be pulled back into the housing by the restoring element (11) and the arresting element (8) can be pressed out of one of the guideways via one of the ramps (22) into the control guideway

(27) and the arresting element (8) can be brought into the arresting-element arresting position (21), so that the rotation of the reel (7) relative to the housing is blocked, and wherein the reel (7) can be rotated relative to the housing when the arresting element (8) is outside the arresting-element arresting position (21), and
wherein the arresting element (8) can be guided out of the arresting-element arresting position (21) via one of the ramps (22) onto the control guideway (27) and/or one of the guideways and the pulling element (4) can be pulled out of the housing and/or rolled up onto the reel (7) when a pulling force directed away from the housing acts on the pulling element (4) and is greater than the force exerted on the reel (7) by the restoring element (11).

2. The equipment-securing means (100) according to claim 1, characterised in that a freewheel element (10) is designed as a leg spring (37) or torsion spring, wherein the leg spring or torsion spring is fixed to an encircling pin (29) on the reel (7) and wherein one end, in particular one leg, of the leg spring (37) or torsion spring is connected to the control-runway element (9) so that the control-runway element (9) can freely rotate only in the free-running direction.

3. The equipment-securing means (100) according to claim 1, characterised in that the restoring element (11) is designed as a spiral spring or torsion spring.

4. The equipment-securing means (100) according to claim 1, characterised in that the arresting element (8) comprises an arresting-element pin (19) that engages in the control-runway element (9) and is guided in the guideways of the control-runway element (9).

5. The equipment-securing means (100) according to claim 1, characterised in that the arresting element (8) is designed as a slider and is displaceable along an axis along guides provided on and/or in the housing.

6. The equipment-securing means (100) according to claim 1, characterised in that the arresting element (8) is designed as a lever (40), wherein the lever (40) is mounted on the housing and extends in the direction of the control-runway element (9).

7. The equipment-securing means (100) according to claim 1, characterised in that one of the guideways is designed as a free-running guideway (25) and the other of the guideways is designed as a locking guideway (36), wherein the free-running guideway (25) has a directed unidirectional connection to the locking guideway (36) and wherein the locking guideway (36) has a directed unidirectional connection to the arresting-element arresting position (21).

8. The equipment-securing means (100) according to claim 1, characterised in that the arresting-element arresting position (21) has a directed unidirectional connection to the control guideway (27), it being provided in particular that the control guideway (27) is designed as an unlocking-extension guideway.

9. The equipment-securing means (100) according to claim 1, characterised in that the control guideway (27) has a directed unidirectional connection to the free-running guideway (25).

10. The equipment-securing means (100) according to claim 1, characterised in that the ramps (22) for establishing a directed unidirectional connection between the guideways (25, 36, 27) each have the following:
a ramp free-running side (24) which allows the arresting element (8), in particular the arresting-element pin (19) of the arresting element (8), to pass into another guideway (25, 36, 27), and
a ramp locking side (23) that blocks the arresting element (8), in particular the arresting element pin (19) of the arresting element (8), from passing into another guideway (25, 36, 27), in particular for blocking the arresting element pin (19) of the arresting element (8) along the edge of the ramp (22).

11. The equipment-securing means (100) according to claim 1, characterised in that the control guideway (27) has a stop at one end, in particular at an unlocking-extension guideway end (28), so that the arresting element (8), in particular the arresting element pin (19) of the arresting element (8), is blocked at that end in the control guideway (27).

12. The equipment-securing means (100) according to claim 1, characterised in that at least one of the guideways is of annular form and/or that the control guideway (27) is of annular-sector form, in particular spanning a semicircle or a three-quarter circle.

13. The equipment-securing means (100) according to claim 1, characterised in that, during rewinding, the arresting element (8) can, when a tensile force directed away from the housing and less than the force exerted on the reel (7) by the restoring element (11) acts once more on the pulling element (4), be pushed from one of the guideways via one of the ramps (22) into the control guideway (27) and brought back into the arresting-element arresting position (21).

14. The equipment-securing means (100), for portable items of equipment, in particular portable tools, comprising:
a housing in which a reel (7) and a restoring element (11) are arranged, wherein the reel (7) is arranged in the housing and is mounted so that it can rotate relative to the housing,
a pulling element (4) for fastening items of equipment, wherein the pulling element (4) is completely rolled up on the reel (7) in a starting state and one end of the pulling element (4) projects from the housing,
wherein the restoring element (11) is arranged between the housing and the reel (7) in such a way that the restoring element (11) exerts a tensile force on the reel (7) in the direction of an interior of the housing, so that the pulling element (4) can be rolled up onto the reel (7),
wherein the pulling element (4), when a tensile force directed away from the housing which is greater than the force exerted on the reel (7) by the restoring element (11) acts on the pulling element (4), can be unrolled to an end position in which the pulling element (4) is completely unrolled from the reel (7), and can be pulled out of the housing relative to the latter, and
wherein the pulling element (4) has at least one predetermined breaking connection for fall damping in an area of its end fixed to the reel (7), wherein the predetermined breaking connection is designed so that when a pulling force directed away from the housing and exceeding a predefined force threshold value acts on the pulling element (4) after the pulling element (4) has reached the end position, the connection breaks to absorb the pulling force and thus damp the fall, and
further comprising:
an arresting mechanism comprising:
a control-runway element (9) that is connected to the reel (7) via a freewheel (10) and has two concentrically extending guideways spaced radially apart, in particular of annular or annular-sector form, and a control guideway (27) extending concentrically between them, likewise of annular or annular-sector form, the control guideway (27) having an arresting-element arresting position (21) and ramps (22) being arranged between the individual guideways, and
an arresting element (8) that engages in the control-runway element (9) and is guided in the guideways and the control guideway (27) and/or along the ramps (22) of the control-runway element (9), and
wherein the guideways, the control guideway (27) and the ramps (22) are designed and arranged relative to one another so that by pulling on the pulling element (4) with a force which is greater than the force exerted by the restoring element (11) on the reel (7), the pulling element (4) can be pulled out of the housing and the arresting element (8) can be guided freely in one of the guideways, so that the control-runway element (9) rotates with the reel (7), so that when a pulling force directed away from the housing acts on the pulling element (4), which force is smaller than the force exerted by the restoring element (11) on the reel (7), the pulling element

(4) can be pulled back into the housing by the restoring element (11) and the arresting element (8) can be guided freely in one of the guideways via one of the ramps (22) into the control guideway (27), the pulling element (4) can be pulled back into the housing by the restoring element (11) and the arresting element (8) can be pressed out of one of the guideways via one of the ramps (22) into the control guideway (27), and the arresting element (8) can be brought into the arresting-element arresting position (21), so that the rotation of the reel (7) relative to the housing is blocked, and wherein the reel (7) can be rotated relative to the housing when the arresting element (8) is outside the arresting-element arresting position (21), and
wherein the arresting element (8) can be guided out of the arresting-element arresting position (21) via one of the ramps (22) onto the control guideway (27) and/or one of the guideways and the pulling element (4) can be pulled out of the housing and/or rolled up onto the reel (7) when a pulling force directed away from the housing acts on the pulling element (4) and is greater than the force exerted on the reel (7) by the restoring element (11).

15. The equipment-securing means (100) according to claim 14, characterised in that a plurality of predetermined breaking connections are arranged one after the other over a circumferential section of the reel (7) in a winding direction of the pulling element (4) around the reel (7), it being provided in particular that the predetermined breaking connections extend over at least 25% of a winding of the pulling element (4) around the reel (7), in particular over 50% to 300% of a winding.

16. The equipment-securing means (100) according to claim 14, characterised in that the predetermined breaking connections are formed as a plurality of interconnected pulling-element sections (46) overlapping one another in a winding direction, with the pulling-element sections connected to one another by sewing or gluing.

17. The equipment-securing means (100) according to claim 16, characterised in that the force threshold value is the seam tear force or adhesive fracture force.
